(19) United States
(12) Patent Application Publication
(10) Pub. No.: US 2023/0311243 A1
(43) Pub. Date: Oct. 5, 2023

(54) LASER WELDING METHOD AND LASER WELDING DEVICE

(71) Applicant: FURUKAWA ELECTRIC CO., LTD., Tokyo (JP)

(72) Inventors: Nobuyasu MATSUMOTO, Tokyo (JP); Tomomichi YASUOKA, Tokyo (JP); Sayo SUGA, Tokyo (JP); Toshiaki SAKAI, Tokyo (JP); Masamitsu KANEKO, Tokyo (JP); Takashi SHIGEMATSU, Tokyo (JP); Kazuyuki UMENO, Tokyo (JP); Jun TERADA, Tokyo (JP)

(73) Assignee: FURUKAWA ELECTRIC CO., LTD., Tokyo (JP)

(21) Appl. No.: 18/301,459

(22) Filed: Apr. 17, 2023

Related U.S. Application Data
(63) Continuation of application No. PCT/JP2021/038448, filed on Oct. 18, 2021.

(30) Foreign Application Priority Data
Oct. 20, 2020 (JP) 2020-176331

(51) Int. Cl. B23K 26/06; B23K 26/24

(52) U.S. Cl. CPC B23K 26/0608; B23K 26/24; G02B 27/0944

(57) ABSTRACT

A laser welding method includes: forming a molten weld pool by emitting laser light including a main power region and a sub-power region onto a workpiece, the main power region including at least one main beam, the sub-power region including at least one sub-beam having a lower power density than power density of the main beam; and solidifying the molten weld pool. The sub-beam is emitted onto the workpiece such that a void formed inside the molten weld pool escapes to outside of the molten weld pool before the molten weld pool becomes solidified.

### REFERENCE TO RELATED APPLICATION(S)

This application is a continuation of International Application No. PCT/JP2021/038448, filed on Oct. 18, 2021 which claims the benefit of priority of the prior Japanese Patent Application No. 2020-176331, filed on Oct. 20, 2020, the entire contents of which are incorporated herein by reference.

### BACKGROUND OF THE INVENTION

The present disclosure relates to a laser welding method and a laser welding device.

A technology for performing laser welding of a plurality of metallic members, such as rectangular wires, is known (for example, Japanese Patent No. 6674588).

### SUMMARY OF THE INVENTION

As far as laser welding of metallic members, which are not limited to rectangular wires, is concerned; in case voids get formed inside the welded part, then the required joint strength cannot be achieved. Moreover, even if an appearance inspection is done, it is difficult to check the presence or absence of voids.

In that regard, it is desirable to provide a new and improved laser welding method and a new and improved laser welding device that, for example, enable holding down the formation of voids.

In some embodiments, a laser welding method includes: forming a molten weld pool by emitting laser light including a main power region and a sub-power region onto a workpiece, the main power region including at least one main beam, the sub-power region including at least one sub-beam having a lower power density than power density of the main beam; and solidifying the molten weld pool. The sub-beam is emitted onto the workpiece such that a void formed inside the molten weld pool escapes to outside of the molten weld pool before the molten weld pool becomes solidified.

In some embodiments, a laser welding device includes: a laser oscillator; and an optical head configured to emit laser light radiated from the laser oscillator, onto a workpiece. The laser light includes at least one main beam and includes at least one sub-beam having lower power density than power density of the main beam, and the laser light is emitted such that molten weld pool is formed on the workpiece, and the sub-beam is emitted onto the workpiece such that a void formed inside the molten weld pool escapes to outside of the molten weld pool before the molten weld pool becomes solidified.

The above and other objects, features, advantages and technical and industrial significance of this disclosure will be better understood by reading the following detailed description of presently preferred embodiments of the disclosure, when considered in connection with the accompanying drawings.

### BRIEF DESCRIPTION OF THE DRAWINGS

FIG. 1 is an exemplary diagram illustrating an overall configuration of a laser welding device according to a first embodiment;

FIG. 2 is an exemplary and schematic side view of a pre-welding state of a workpiece in a laser welding method according to the first embodiment;

FIG. 3 is an exemplary and schematic side view of a post-welding state of the workpiece in the laser welding method according to the first embodiment;

FIG. 4 is an explanatory diagram for explaining the concept of the principle of a diffractive optical element included in the laser welding device according to the first embodiment;

FIGS. 5 to 8 are diagrams illustrating examples of beams (spots) formed on an outer surface of a workpiece in the laser welding device according to the first embodiment;

FIG. 9 is an exemplary and schematic side view of a workpiece during a process of forming a molten weld pool in the laser welding method according to the first embodiment;

FIG. 10 is an exemplary and schematic planar view of sweeping routes of laser lights on a workpiece in the laser welding method according to the first embodiment;

FIG. 11 is an exemplary schematic diagram illustrating the temporal change in the temperature of the molten weld pool and the temporal change in the output of a laser device in the laser welding method according to the first embodiment;

FIG. 12 is an exemplary and schematic perspective view of a rectangular wire that includes a member representing a workpiece in the laser welding method according to the first embodiment;

FIG. 13 is an exemplary and schematic side view illustrating a welded part formed as a result of implementing the laser welding method according to the first embodiment;

FIG. 14 is an exemplary diagram illustrating an overall configuration of a laser welding device according to a second embodiment;

FIG. 15 is a graph illustrating the light absorption rate of each metallic material with respect to the wavelength of the emitted laser light;

FIG. 16 is an exemplary and schematic diagram illustrating the temporal change in the temperature of a molten weld pool and the temporal change in the output of the laser lights coming from laser devices in a laser welding method according to the second embodiment;

FIG. 17 is an exemplary and schematic side view of a workpiece during a maintenance process for maintaining a molten weld pool in the laser welding method according to the second embodiment;

FIGS. 18 to 20 are exemplary and schematic planar views illustrating the sweeping routes of laser light with respect to the molten weld pool in the laser welding method according to the second embodiment;

FIG. 21 is an exemplary block diagram of the laser welding devices according to the embodiments;

FIG. 22 is an exemplary flowchart for explaining a flow of operations performed to output an examination result in the laser welding devices according to the embodiments; and

FIG. 23 is an exemplary flowchart for explaining a flow of operations performed for void suppression control in the laser welding devices according to the embodiments.

### DETAILED DESCRIPTION

Exemplary embodiments of the disclosure are described below. The configurations explained in the embodiments described below as well as the actions and the results (effects) attributed to the configurations are only exemplary. The disclosure can be implemented also using some different configuration than the configurations disclosed in the embodiments described below. Meanwhile, according to the disclosure, it becomes possible to achieve at least one of various effects (including secondary effects) that are attributed to the configurations.

The embodiments described below include identical constituent elements. In the following explanation, the identical constituent elements are referred to by the same reference numerals, and their explanation is not given in a repeated manner.

Moreover, in the drawings, the X direction is indicated by an arrow X, the Y direction indicated by an arrow Y, and the Z direction is indicated by an arrow Z. The X direction, the Y direction, and the Z direction intersect with each other and are orthogonal to each other. The Z direction is the direction of extension of a plurality of members constituting a workpiece W. Herein, although the Z direction is oriented substantially vertically upward, it can alternatively be inclined with respect to the vertically upward direction.

In the present written description, ordinal numbers are assigned only for convenience and with the aim of differentiating among the components, among the parts, and among the directions. Thus, the ordinal numbers do not indicate the priority or the sequencing.

### First Embodiment

### Configuration of Laser Welding Device

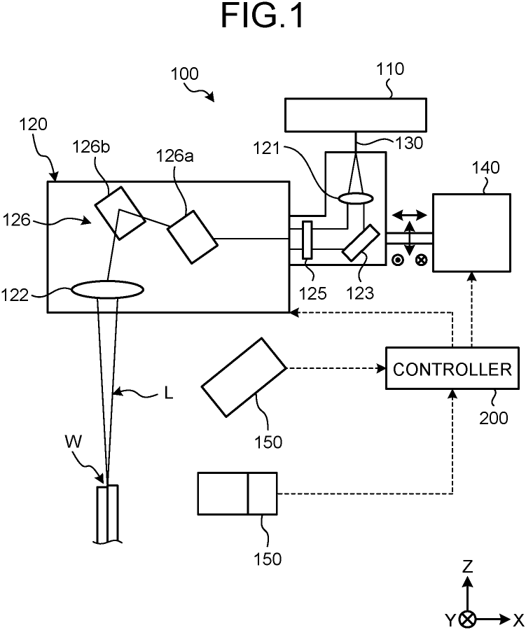

FIG. 1 is a diagram illustrating an overall configuration of a laser welding device 100 according to a first embodiment. As illustrated in FIG. 1, the laser welding device 100 includes a laser device 110, an optical head 120, an optical fiber 130, a driving mechanism 140, a sensor 150, and a controller 200.

The laser welding device 100 emits laser lights L onto the outer surface of the workpiece W that is to be laser-welded. Due to the energy of the laser lights L, the workpiece W undergoes partial melting and then becomes cool and solidified. As a result, the workpiece W gets welded. The workpiece W includes a plurality of members. Thus, when the workpiece W is subjected to laser welding, the members get jointed together.

Each of the members constituting the workpiece W can be manufactured using, for example, the following: a copper based metallic material such as copper or a copper alloy; an aluminum based metallic material such as aluminum or an aluminum alloy; a nickel based metallic material such as nickel or a nickel alloy; an iron based metallic material such as iron or an iron alloy; or titanium based metallic material such as titanium or a titanium alloy. Herein, the members can be made of the same metallic material, or can be made of mutually different materials. Meanwhile, the members constituting the workpiece W may or may not be conducting bodies.

The laser device 110 includes a laser oscillator and, as an example, is configured to output a single-mode laser light having the power of few kW. Alternatively, for example, the laser device 110 can include a plurality of internal semiconductor laser devices and can be configured in such a way that the semiconductor laser devices collectively output a single-mode laser light having the power of few kW. Moreover, the laser device 110 can include various types of laser light sources such as fiber lasers, YAG lasers, and disk lasers. Furthermore, for example, the laser device 110 outputs the laser light having the wavelength equal to or greater than 400 [nm] and equal to or smaller than 1200 [nm].

The optical fiber 130 is optically connected to the laser device 110 and the optical head 120. In other words, the optical fiber 130 guides the laser light, which is output from the laser device 110, to the optical head 120. When the laser device 110 outputs a single-mode laser light, the optical fiber 130 is configured to propagate the single-mode laser light. In that case, the M² beam quality of the single-mode laser light is set to be equal to or smaller than 1.3. The M² beam quality can also be called the M² factor.

The optical head 120 is an optical device meant for emitting the laser light, which is input from the laser device 110, toward the workpiece W. The optical head 120 includes a collimator lens 121, a collecting lens 122, a mirror 123, a diffractive optical element (DOE) 125, and a galvanic scanner 126. The collimator lens 121, the collecting lens 122, the mirror 123, the DOE 125, and the galvanic scanner 126 are also called optical components.

The collimator lens 121 collimates each laser light input via the optical fiber 130. The laser lights subjected to collimation represent collimated lights.

The mirror 123 reflects the laser lights representing the collimated lights obtained at the collimator lens 121, and directs the reflected lights toward the galvanic scanner 126. Meanwhile, in between the mirror 123 and the galvanic scanner 126, the DOE 125 is installed. Regarding the DOE 125, the explanation is given later.

The galvanic scanner 126 includes a plurality of mirrors 126a and 126b, and controls the angles of the mirrors 126a and 126b so as to change the direction of radiation of the laser lights L from the optical head 120. That enables changing the position of irradiation of the laser lights L onto the outer surface of the workpiece W. The angles of the mirrors 126a and 126b can be changed by, for example, a motor (not illustrated) that is controlled by the controller 200. While radiating the laser lights L, when the direction of radiation of the laser lights L is changed, it becomes possible to sweep the laser lights L at the outer surface of the workpiece W.

The collecting lens 122 collects the laser lights coming from the galvanic scanner 126 in the form of the collimated lights, and emits the collected laser lights as the laser lights L (the output light) toward the workpiece W.

Meanwhile, the optical components included in the optical head 120 are not limited to the optical components explained above, and can also include other optical components.

The driving mechanism 140 changes the relative position of the optical head 120 with respect to the workpiece W. For example, the driving mechanism 140 includes: a rotation mechanism such as a motor; a deceleration mechanism for decelerating the rotation output of the rotation mechanism; and a motion conversion mechanism for converting the post-deceleration rotation, which has been decelerated by the deceleration mechanism, into the linear motion. The controller 200 can control the driving mechanism 140 in such a way that the relative position of the optical head 120 changes with respect to the workpiece W in the X direction, the Y direction, and the Z direction. The driving mechanism 140 can change (switch) the workpiece W to be subjected to laser welding, from among a plurality of workpieces W supported by a support mechanism (not illustrated). Moreover, the driving mechanism 140 can change the position of irradiation of the laser lights L onto the workpiece W. Furthermore, the driving mechanism 140 can be used in changing the point of irradiation accompanying a change in the direction of irradiation of the laser lights with respect to the workpiece W. Moreover, while the laser lights L are being emitted onto the outer surface of the workpiece W, the driving mechanism 140 can change the position of irradiation. That is, the driving mechanism 140 is capable of sweeping the laser lights L at the outer surface of the workpiece W.

The sensor 150 detects the temperature of a molten weld pool that gets formed on the workpiece W due to the irradiation of the laser lights L. Examples of the sensor 150 include a radiation thermometer or an infrared thermography camera.

The controller 200 controls the operations of the laser device 110, the driving mechanism 140, and the galvanic scanner 126 based on the detection result obtained by the sensor 150. The laser device 110, the driving mechanism 140, and the galvanic scanner 126 are capable of changing the irradiation state of the laser lights L that are emitted from the optical head 120 onto the workpiece W. That is, the laser device 110, the driving mechanism 140, and the galvanic scanner 126 represent an example of a variation causing mechanism and can be referred to as the control targets for the controller 200.

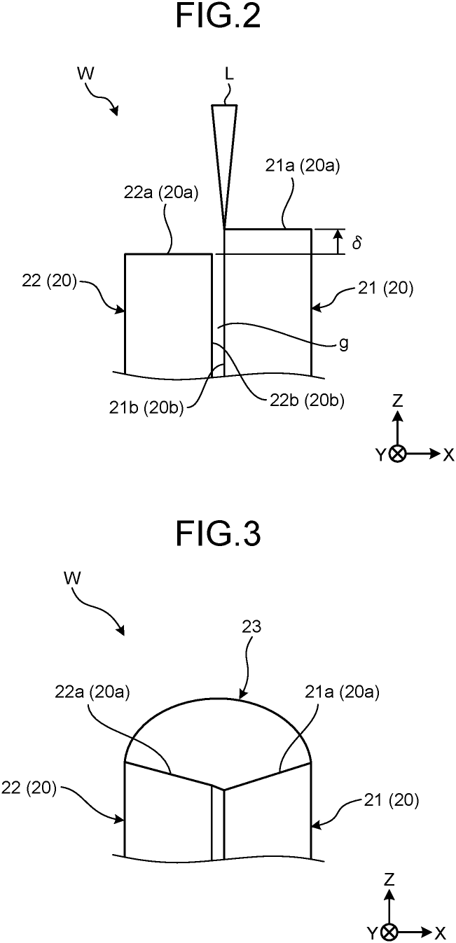

FIG. 2 is a side view of the pre-welding state of the workpiece W. As illustrated in FIG. 2, the workpiece W includes two members 20 (21 and 22). Each member 20 is made of a metallic material.

Both members 20 extend in the Z direction and have an end portion 20a (21a and 22a). The end portions 20a expand while intersecting with the Z direction. That is, the end portions 20a extend in the X direction and the Y direction. Herein, the Z direction represents an example of a first direction.

Both members 20 are placed adjacent to each other in the X direction that intersects with the Z direction, and are arranged along the X direction. In between the side faces 21b and 22b (20b) that face each other in the X direction, a gap g is formed. The size of the gap g is equal to or greater than zero. That is, the members 20 can be at least in partial contact with each other. Herein, the X direction represents an example of a second direction.

In the first embodiment, it is assumed that there a misalignment δ equal to or greater than zero between the end portion 21a of the member 21 and the end portion 22a of the member 22 in the Z direction. Herein, of the two members 20 placed in such a relative positional relationship, the end portion 21a that is either at the same position as the position of the end portion 22a in the Z direction or at a misalignment with respect to the end portion 22a in the Z direction represents an example a first end portion; and the end portion 22a that is at a misalignment with respect to the end portion 21a in the opposite direction of the Z direction represents an example of a second end portion. The member 21 that includes the end portion 21a represents an example of a first member, and the member 22 that includes the end portion 22a represents an example of a second member. The member 21 (the first member) can also referred to as a relatively-projecting member in the Z direction, and the member 22 (the second member) can also referred to as a relatively-recessed member.

At the time of welding the workpiece W, that is, welding the two members 20, the optical head 120 emits the laser lights L toward the end portions 20a. The direction of irradiation of the laser lights L is either in the opposite direction of the Z direction or in a direction that is inclined with respect to the opposite direction of the Z direction.

FIG. 3 is a side view of the post-welding state of the workpiece W. As illustrated in FIG. 3, as a result of irradiation of the laser lights L onto the end portions 20a, the two members 20 get welded at the end portions 20a, and a welded part 23 is formed in a bridged manner over the two end portions 20a. The welded part 23 is formed when a molten weld pool that is formed in a bridged manner between the two end portions 20a is cooled so that it becomes solidified. The molten weld pool that is a fluid metallic material has a bulgy shape in the Z direction due to the surface tension. Accordingly, the welded part 23, which represents the molten weld pool in the solidified form, also has a bulgy shape in the Z direction. The welded part 23 mechanically joins the two members 21 and 22 to each other. Moreover, if the two members 21 and 22 are made of a metal having an electrically conductive property, then the welded part 23 electrically connects the two members 21 and 22 to each other.

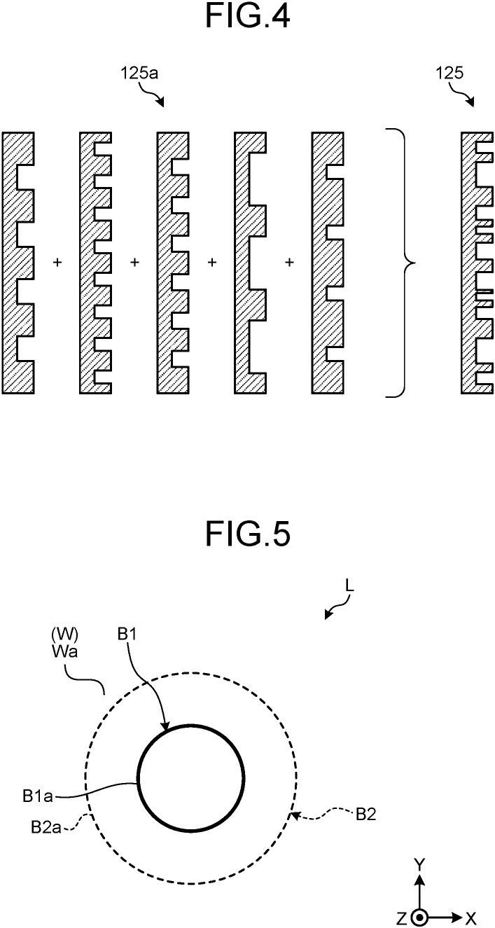

Meanwhile, as explained earlier, the optical head 120 includes the DOE 125 that performs shaping of the shapes of the beams (hereinafter, called the beam shape) of the laser lights. FIG. 4 is an explanatory diagram for explaining the concept of the principle of the DOE 125. As conceptually illustrated in FIG. 4, for example, the DOE 125 is configured by superposing a plurality of diffraction gratings 125a having different pitch lengths. The DOE 125 can bend or superpose the collimated lights in the directions affected by the diffraction gratings 125a, and can obtain the beam shape. The DOE 125 can also be referred to as a beam shaper.

### Shape of Beam (spot)

The DOE 125 divides a collimated laser light into a plurality of beams. FIGS. 5 to 8 are diagrams illustrating examples of the beams of the laser lights L as formed on an outer surface Wa of the workpiece W. In FIGS. 5 to 8, for the sake of simplicity, a beam B1 is illustrated as a solid line, and a beam B2 is illustrated as a dashed line. Meanwhile, if the DOE 125 is replaced by another type, then the optical head 120 can be made to output laser light including a plurality of beams having various placements. Herein, the DOE 125 represents an example of beam shaper.

The DOE 125 divides the laser light into a plurality of beams. The divided beams include at least one beam B1 and at least one beam B2. The beam B2 has a lower power density than the power density of the beam B1. Herein, the beam B1 represents an example of a main beam, and the beam B2 represents an example of a sub-beam. Moreover, the beam B1 constitutes a main power region, and the beam B2 constitutes a sub-power region.

In the example illustrated in FIG. 5, on the outer surface Wa, the spot of a single beam B1 is formed, and the spot of the beam B2 is formed to be wider than the spot of the beam B1. The beam B1 and an outer edge B1a thereof are positioned on the inside of an outer edge B2a of the beam B2. Meanwhile, the beams B1 and B2 can be placed either in a concentric manner or in an eccentric manner. Moreover, the outer edge B1a can be inscribed in the outer edge B2a.

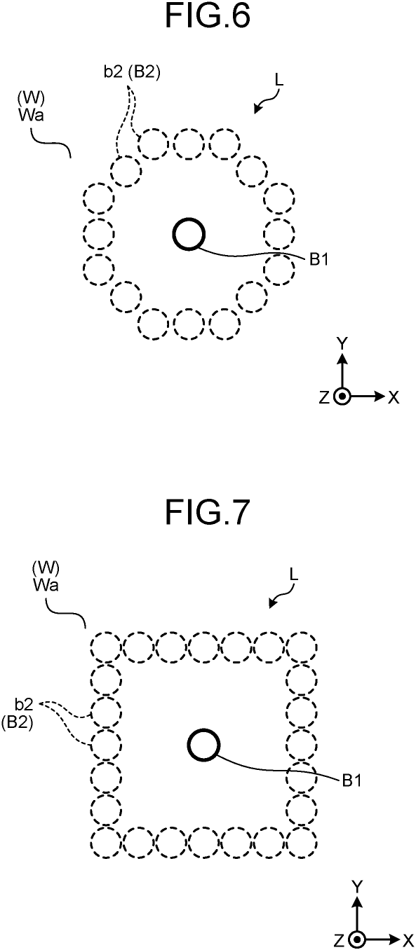

In the example illustrated in FIG. 6, on the outer surface Wa, the spot of a single B1 is formed, and the spots of a plurality of beams b2 is formed in an enclosing manner around the beam B1. The beams b2 are arranged in a substantially annular manner. Herein, the beams b2 represent an example of sub-beams. Moreover, a sub-power region is formed by the beams b2.

In the example illustrated in FIG. 7, the spot of a single beam B1 is formed, and the spots of a plurality of beams b2 are formed in an enclosing manner around the beam B1. The beams b2 are arranged in a substantially quadrangular manner, that is, arranged along the edges of a virtual quadrangle. Herein, the beams b2 represent an example of sub-beams, and a sub-power region is formed by the beams b2.

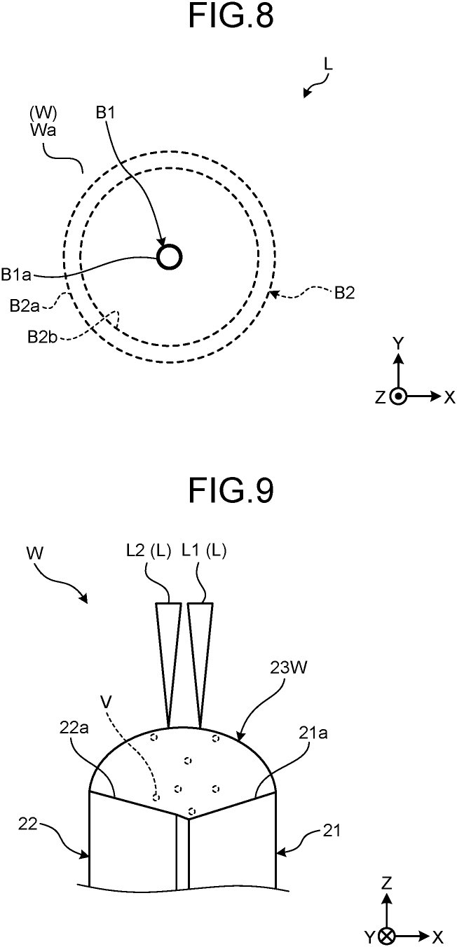

In the example illustrated in FIG. 8, on the outer surface Wa, the spot of a single beam B1 is formed, and the spot of a single ring-like beam B2 is formed in an enclosing manner around the beam B1. The beam B1 and the outer edge B1a thereof are positioned on the inside of the inner edge B2b of the beam B2. Meanwhile, although the beam B2 has an annular shape, that is not the only possible case. For example, the beam B2 can have some other shape such as the shape of a rectangular frame. Moreover, the beam B2 can be partially notched.

### Laser Welding Method

FIG. 9 is a side view of the workpiece W during a process of forming a molten weld pool 23W (hereinafter, referred to as a formation process) in a laser welding method. Meanwhile, in the following explanation, for the purpose of illustration, the laser light L emitted onto the end portion 21a of the member 21 is referred to as laser light L1, and the laser light L emitted onto the end portion 22a of the member 22 is referred to as laser light L2. The laser lights L1 and L2 are radiated from the same optical head 120.

Firstly, as illustrated in FIG. 9, when at least either the laser light L1 (L) is emitted onto the end portion 21a of the member 21 or the laser light L2 (L) is emitted onto the end portion 22a of the member 22, the molten weld pool 23W is formed in a bridged manner between the end portions 21a and 22a. The molten weld pool 23W is formed as a result of welding of the metallic materials of the members 21 and 22. In other words, the molten weld pool 23W includes the metallic materials of the members 21 and 22. Moreover, the molten weld pool 23W is in a fluid state.

In that case, there are times when voids V are formed inside the molten weld pool 23W. The voids V lead to a decline in the welding strength attributed to the welded part 23. Hence, it is desirable that the voids V are no more present in the solidified state.

The laser lights L can be swept in the emitted state. FIG. 10 is an explanatory diagram illustrating sweeping routes of the laser lights L1 and L2 (L) in the end portions 21a and 22a, respectively. As illustrated in FIG. 10, for example, in a region A1 that is on the side of the end portion 22a with reference to a center C1 in the X direction of the end portion 21a, the laser light L1 is linearly swept in the Y direction intersecting with the X direction. Moreover, for example, in a region A2 that is on the side of the end portion 21a with reference to a center C2 in the X direction of the end portion 22a, the laser light L2 is linearly swept in the Y direction intersecting with the X direction. In the regions A1 and A2, the sweeping of the laser lights L1 and L2 can be performed for a plurality of number of times.

In this way, it is a known fact that, when the laser lights L1 and L2 are linearly swept, the voids V in the molten weld pool 23 become smaller. That is believed to be possible because of being able to hold down the disturbance in the flow of the fluid metallic material inside the fluid molten weld pool 23W. Moreover, as a result of performing to-and-fro linear sweeping, the heat energy can be applied as needed to a wider area of the molten weld pool 23W, thereby making it possible to hold down the occurrence of regional cooling and solidification of the molten weld pool 23W.

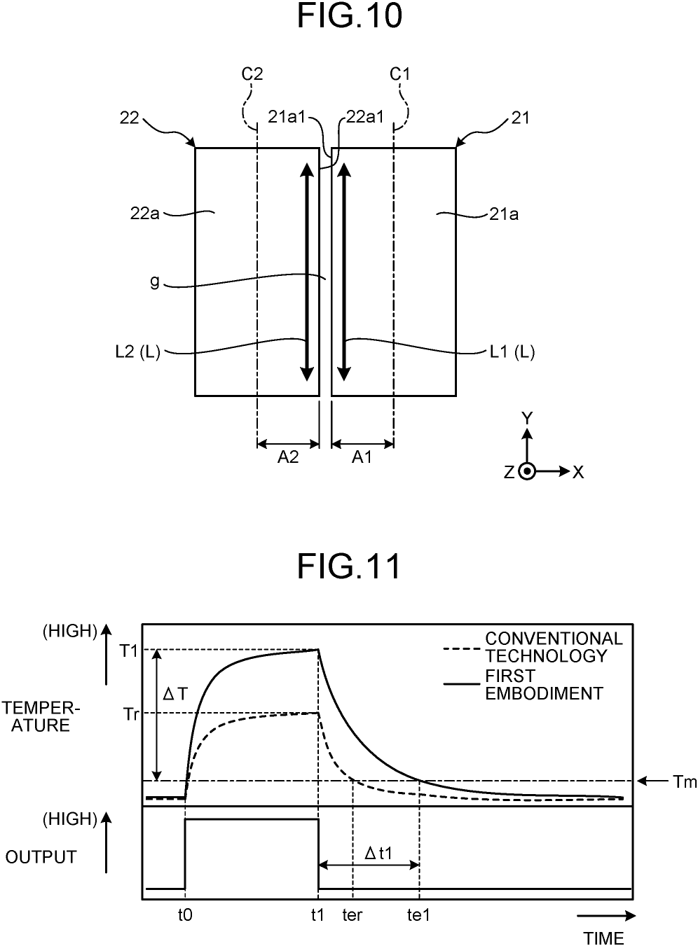

FIG. 11 is a diagram illustrating the temporal change in the temperature of the molten weld pool 23W and the temporal change in the output of the laser light coming from the laser device 110 during welding according to the first embodiment. In FIG. 11, regarding the temperature, the temporal change during laser welding according to the first embodiment is illustrated using a solid line. Moreover, for the purpose of comparison, as a conventional technology, in the case of obtaining an identical welded part 23 on the workpiece W by emitting a single-beam laser light, the temporal change during laser welding is illustrated using a dashed line.

As illustrated in FIG. 11, in the first embodiment, the laser device 10 starts the output at a timing t0 and stops the output at a timing t1. After the timing t1, the molten weld pool 23W is naturally cooled in the ordinary temperature atmosphere. Accordingly, the temperature of the molten weld pool 23W drops in a gradual manner.

In the conventional technology, as indicated by the dashed line, a temperature Tr of the molten weld pool 23W drops to a melting temperature Tm at a timing ter. In contrast, in the first embodiment, as indicated by the solid line, the temperature T1 of the molten weld pool 23W drops to the melting temperature Tm at a timing tel that arrives later than the timing ter. At a temperature higher than the melting temperature Tm, the molten weld pool 23W is in the molten state. Herein, the temperature T1 represents the temperature during the formation process for forming the molten weld pool 23W and, as an example, is equal to the maximum temperature during the formation process.

As is clear from FIG. 11, in the first embodiment, at the time of formation of the molten weld pool 23W, the temperature T1 of the molten weld pool 23W, that is, the temperature T1 of the molten weld pool 23W in the state in which the laser device 110 is radiating the laser light is higher than the temperature Tr of the molten weld pool 23W according to the conventional technology. That is because of the fact that, as explained earlier, for example, the laser light L1 includes a plurality of beams B1 and B2 as illustrated in FIGS. 5 to 8. That is, when the laser light L includes the beams B1 and B2, even when the temperature of the molten weld pool 23W becomes higher; in the molten weld pool 23W in the molten state, that is, in the fluid state, disturbance in the flow or sputtering is not easy to occur and the voids V too are not easily formed. Hence, as comparted to a single beam, the output of the laser light L can be increased and the temperature T1 of the molten weld pool 23W can be further risen. In turn, a temperature difference ΔT (=T1-Tm) between the temperature T1 and the melting temperature Tm of the molten weld pool 23W can be set to be greater than the temperature difference in the case of using a single beam. Hence, according to the first embodiment, the temperature T1 of the molten weld pool 23W can be increased while ensuring that the welding quality is not affected. As a result, as compared to the case of using a single beam, it becomes possible to increase a temperature drop period Δt1 (=te1-t1) that is required for the temperature T1 of the molten weld pool 23W to drop to the melting temperature Tm.

Moreover, in the first embodiment, the speed of the temperature drop after the timing t1 is slower (lower) as compared to the conventional technology. That too is attributed to the fact that the laser light L includes the beams B1 and B2 as illustrated in FIGS. 5 to 8. That is, since the laser light L includes the beam B2 having a lower density, after the molten weld pool 23W has been formed, a more moderate temperature distribution can be achieved over a wider range of the workpiece W as compared to the temperature distribution achieved in the case of using a single beam. As a result, after stopping the irradiation of the laser light L, it becomes possible to hold down sudden cooling of the workpiece W. Hence, according to the first embodiment, in that regard too, the temperature drop period Δt1 that is required for the temperature T1 of the molten weld pool 23W to drop to the melting temperature Tm can be increased as compared to the case of using a single beam.

In the molten state of the molten weld pool 23W, that is, in the fluid state of the molten weld pool 23W, the voids V representing air bubbles in the molten weld pool 23W rise upward inside the molten weld pool 23W and escape to the outside of the molten weld pool 23W. Hence, longer the period of time for which the molten weld pool 23W is in the molten state, a greater number of voids V are discharged out of the molten weld pool 23W. Consequently, there is a decrease in the number of voids V remaining in the solidified welded part 23. In that regard, as explained earlier, according to the first embodiment, since the laser light L includes the beams B1 and B2, the temperature drop period Δt1 becomes longer as compared to the case of using a single beam. Accordingly, the molten weld pool 23W can be maintained in the molten state for a longer period of time. Hence, according to the first embodiment, the welded part 23 can be formed in which the number of voids V is smaller.

According to the study undertaken by the inventors, it was confirmed that, when the beams B1 and B2 were placed as illustrated in FIGS. 5 to 8 and were set to have the power density as explained earlier; as compared to the case of using a single beam, the molten state of the molten weld pool 23W was retained for a longer period of time, and the number of voids V could be further reduced.

According to the first embodiment, the placement and the power density of the beams B1 and B2 is set in such a way that the required temperature T1 of the molten weld pool 23W can be secured that enables at least one of the voids V to escape to the outside of the molten weld pool 23W, and the temperature drop period Δt1 (=te1-t1) can be secured that is required for the temperature T1 to drop to the melting temperature Tm. Meanwhile, the temperature T1 and the temperature drop period Δt1 differ according to the material, the environmental heat dissipation, and the ambient temperature.

### Rectangular Wire

FIG. 12 is a perspective view of a rectangular wire 10 that includes the member 20. As an example, the member 20 represents the core (inner conductor) of the rectangular wire 10 as illustrated in FIG. 12. The rectangular wire 10 includes the member 20 and a cladding 30 for the member 20. The member 20 is made of an electrically conductive metallic material. In the member 20, the cross-sectional shape orthogonal to the direction of extension is substantially quadrangular. The cladding 30 has insulation properties and is made of, for example, enamel or a synthetic resin material. The cladding 30 can include an enamel layer and an extrusion resin layer. The laser welding device 100 is used in welding the end portions 20a of the members 20 that represent the cores of such rectangular wires 10. In that case, in the vicinity of the end portions in the direction of extension of two rectangular wires 10, the cladding 30 is removed. Then, as illustrated in FIG. 2, the end portions of two members 20, which are placed adjacent to each other and which are oriented in the same direction (the direction of extension), are welded using the laser welding device 100.

The rectangular wire 10 can constitute a coil installed in a rotating electrical machine such as a motor or a motor generator. The laser welding method implemented in the laser welding device 100 according to the first embodiment can be used in welding the end portions of mutually adjacent coils that are set in a stator core.

However, the members 20 to be treated as the workpiece W are not limited to the cores of the rectangular wires 10. Alternatively, as illustrated in FIG. 2, as long as the members 20 extend in the Z direction, are adjacent to each other in the X direction, have the end portions 20a close to each other, and have side faces 20b facing the X direction; it serves the purpose. Herein, the members 20 can be tabular members or can be wire rods.

### Voids Remaining Behind in Welded Part

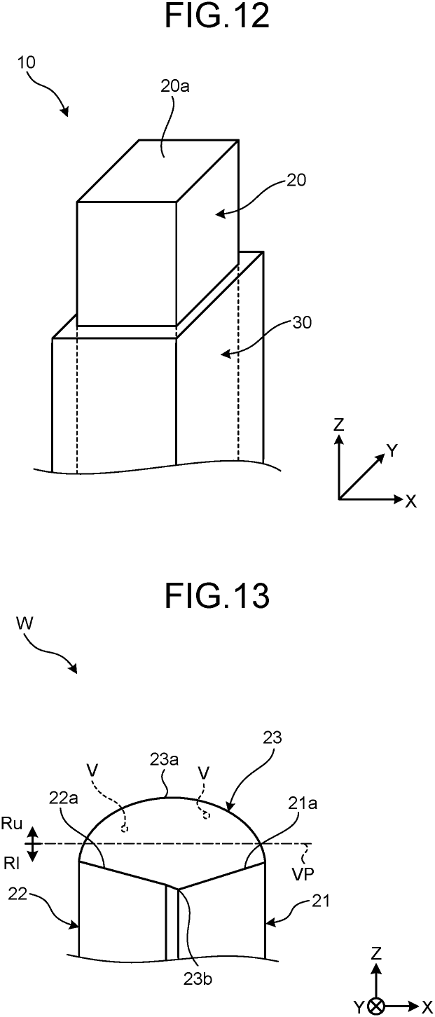

FIG. 13 is an exemplary side view illustrating the welded part 23. In the first embodiment, as illustrated in FIG. 13, the irradiation condition of the laser light L, particularly, the irradiation condition of the beam B2 (sub-beam) is set in such a way that the number of voids V present in a lower half Rl of the welded part 23 is equal to or smaller than the number of voids V present in an upper half Ru of the welded part 23. Herein, a virtual plane VP is assumed to pass through the exact intermediate position between an upper end 23a and a lower end 23b of the welded part 23 in the vertical direction during the welding and the solidification of the welded part 23, and is assumed to spread in the horizontal direction during the welding and the solidification. The upper half Ru is on the upper side of the virtual plane VP, and is opposite to the lower half Rl with reference to the virtual plane VP. Moreover, the lower half Rl of the welded part 23 is on the lower side of the virtual plane VP, and is opposite to the upper half Ru with reference to the virtual plane VP. In the molten weld pool 23W, the voids V move in the upward direction. Hence, when the molten state of the molten weld pool 23W is maintained due to the irradiation of the laser light L (the beam B2), the voids V formed in the lower half Rl move upward toward the upper half Ru or toward the outside of the molten weld pool 23W; and the voids V that could not escape remain behind mainly in the upper half Ru. Hence, such a state of the welded part 23 is attained in which the number of voids V in the lower half Rl is equal to or smaller than the number of voids V in the upper half Ru. That is, the state of the welded part 23 in which the number of voids V present in the lower half Rl is equal to or smaller than the number of voids V present in the upper half Ru can be said to be the state in which the effect of reduction of the voids V due to the irradiation of the beam B2 has been achieved.

In this way, the laser light L, particularly the beam B2 is appropriately set in such a way that the number of voids V present in the lower half Rl is equal to or smaller than the number of voids V present in the upper half Ru.

As a result, it becomes possible to have the required joint strength and the required electrical conductivity, and to form the welded part 23 having a smaller number of voids V. Meanwhile, in the example illustrated in FIG. 13, there are two voids V present in the upper half Ru and there are no voids V present in the lower half Rl. However, the number of voids V is not limited to that example.

As explained above, in the laser welding method and the laser welding device 100 according to the first embodiment, the beam B2 (sub-beam) is emitted onto the workpiece W in such a way that at least one of the voids V, which are formed in the molten weld pool 23 before the solidification of the molten weld pool 23W, escapes to the outside of the molten weld pool 23. Moreover, the beam B1 (main beam) and the beam B2 (sub-beam) are set in such a way that the molten weld pool 23W is formed on the workpiece W and that the temperature of the molten weld pool 23W undergoes temporal change to ensure escape of at least one of the voids V formed in the molten weld pool 23W.

Thus, according to the first embodiment, it becomes possible to reduce a greater number of voids V from the welded part 23. As a result, it becomes possible to hold down any decline in the strength of the welded part 23 as caused by the voids V.

### Second Embodiment

### Configuration of Laser Welding Device

FIG. 14 is a diagram illustrating an overall configuration of a laser welding device 100A according to a second embodiment. As illustrated in FIG. 14, the laser welding device 100A differs from the first embodiment in the way of including a plurality of laser devices 111 and 112 (110) and in the way of including the sensor 150 in an optical head 120A. Moreover, in addition to including the abovementioned constituent elements, the laser welding device 100A differs from the first embodiment in the way that the optical head 120A includes a collimator lens 121-2, filters 124 and 127, and a mirror 128.

Each of the laser devices 111 and 112 (110) includes a laser oscillator. In the second embodiment, the laser devices 111 and 112 output laser lights having different wavelengths.

The laser device 111 outputs first-type laser lights having the wavelength equal to or greater than 800 [nm] and equal to or smaller than 1200 [nm]. The laser device 111 can also be called a first laser device, and the laser oscillator of the laser device 111 can also be called a first laser oscillator.

The laser device 112 outputs second-type laser lights having the wavelength equal to or smaller than 550 [nm]. The laser device 112 can also be called a second laser device, and the laser oscillator of the laser device 112 can also be called a second laser oscillator. Moreover, as an example, the laser device 112 includes a semiconductor laser (element) as a laser light source. Meanwhile, the laser device 112 can output laser light having the wavelength equal to or greater than 400 [nm] and equal to or smaller than 500 [nm].

Along with the installation of the laser device 112, a filter 124 is disposed in the optical head 120A. The first-type laser lights reflect from the mirror 123 and travel toward the filter 124 in the opposite direction of the X direction. Meanwhile, in a configuration in which the first-type laser lights are so input that they travel in the opposite direction of the X direction in the optical head 120A, the mirror 123 is not required.

The filter 124 is, for example, a high-pass filter that transmits the first-type laser lights but that reflects the second-type laser lights without transmitting them. The first-type laser light passes through the filter 124 and travels toward the galvanic scanner 126. The filter 124 reflects the second-type laser lights in the form of the collimated lights obtained at the collimator lens 121-2. After getting reflected from the filter 124, the second-type laser lights also travel toward the galvanic scanner 126.

The filter 127 is disposed in between the mirror 123 and the filter 124. The filter 127 transfers the first-type laser lights, which are coming from the mirror 123, toward the filter 124, and reflects the light that has come from the outer surface Wa of the workpiece W (see FIGS. 5 to 8) and that has passed through the filter 124, toward the mirror 128. The light reflected from the mirror 128 is input to the sensor 150. With such a configuration, the sensor 150 becomes able to take images of the outer surface Wa. The sensor 150 is, for example, an infrared thermography camera capable of detecting the temperature distribution on the outer surface Wa.

Meanwhile, in the second embodiment too, the DOE 125 is installed. The DOE 125 is placed in between the collimator lens 121-2 and the filter 124, and performs shaping of the beams of the second-type laser lights. Alternatively, the optical head 120A can include a DOE that performs shaping of the beams of the first-type laser lights.

Meanwhile, in the laser welding device 100A, the sensor 150 can replaced by the sensor 150 according to the first embodiment. Alternatively, the laser welding device 100 can include the sensor 150 attached to the body of the optical head 120 as explained in the second embodiment.

### Absorption Rate of Wavelength and Light

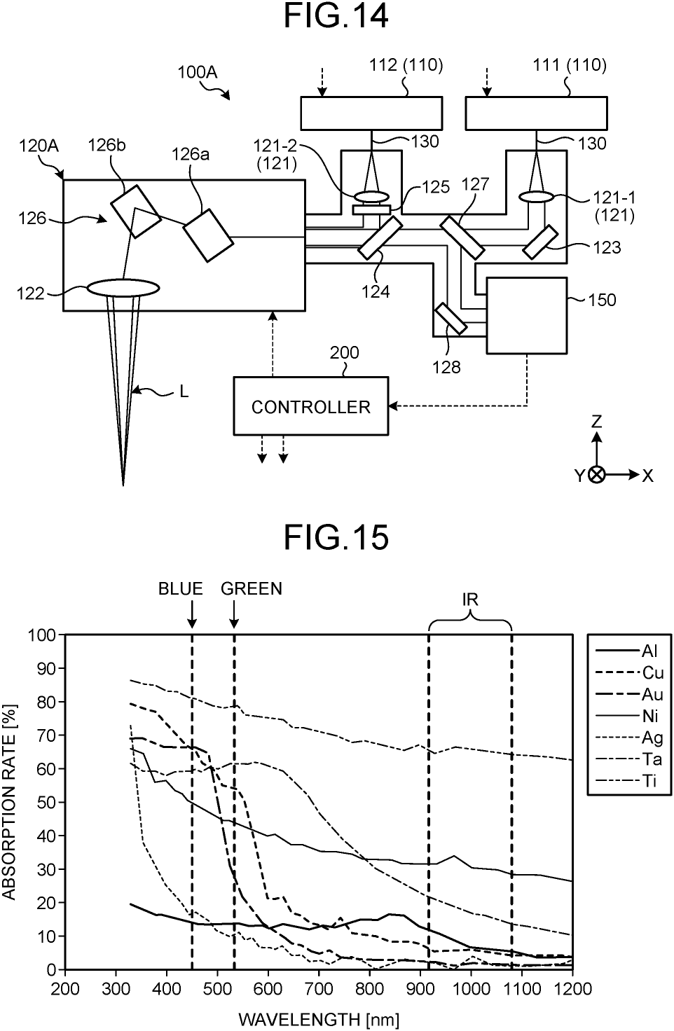

Given below is the explanation of the absorption rates of metallic materials. FIG. 15 is a graph illustrating the light absorption rate of each metallic material with respect to the wavelength of the emitted laser light L. In the graph illustrated in FIG. 15, the horizontal axis represents the wavelength, and the vertical axis represents the absorption rate. In FIG. 15, the relationship between the wavelength and the absorption rate is illustrated regarding aluminum (Al), copper (Cu), gold (Au), nickel (Ni), silver (Ag), tantalum (Ta), and titanium (Ti).

Although different materials exhibit different properties, as far as the metals illustrated in FIG. 15 are concerned, it can be understood that the energy absorption rate is higher when the laser light of blue or green color (a second-type laser light) is used as compared to when the common-purpose infrared (IR) laser light (a first-type laser light) is used. This feature is conspicuous in copper (Cu) and gold (Au).

When the laser light is emitted onto the workpiece W having a relatively lower absorption rate with respect to the used wavelength, the major part of the optical energy gets reflected and does not affect the workpiece W in the form of heat. For that reason, in order to obtain a sufficiently deep welded part, a relatively greater amount of power needs to be applied. In that case, since the energy is rapidly input into the central portion of the beam, it results in sublimation and a keyhole gets formed.

On the other hand, when the laser light is emitted onto the workpiece W having a relatively higher absorption rate with respect to the used wavelength, the major part of the input energy gets absorbed in the workpiece W and is converted into heat energy. In that process, if laser light having a low power density is emitted, it results in melting of the heat conduction type.

Using the optical head 120A according to the second embodiment, the workpiece W can be emitted with the laser lights L that have the beams B1 attributed to the first-type laser lights coming from the laser device 111 and have the beams B2 attributed to the second-type laser lights coming from the laser device 112.

From the explanation given above, by ensuring that the first-type laser lights having the wavelength equal to or greater than 800 [nm] and equal to or smaller than 1200 [nm] are output and that the second-type laser lights having the wavelength equal to or smaller than 500 [nm] are output, and by emitting the second-type laser lights after the workpiece W has melted due to the first-type laser lights; the heat energy can be efficiently applied to the molten weld pool 23W. Hence, it becomes possible to efficiently hold down the occurrence of regional cooling and solidification of the molten weld pool 23W. Meanwhile, in order to emit the second-type laser lights after the workpiece W has melted due to the first-type laser lights, as explained later, the time slots for emitting the first-type laser lights and the time slots for the second-type laser lights can be individually controlled. Alternatively, with respect to the first-type laser lights, at the back of the sweeping direction of the laser light L, at least some past of the second-type laser lights can be emitted. At that time, it can be ensured that there is at least partial overlapping between the region of irradiation of the first-type laser lights and the region of irradiation of the second-type laser lights.

The controller 200 can control the operations of the laser device 111 as well as the operations of the laser device 112. That is, the controller 200 can independently control the time slots for radiation of the first-type laser lights, that is, the beams B1 from the laser device 111, and independently control the time slots for radiation of the second-type laser lights, that is, the beams B2 from the laser device 112.

### Laser Welding Method

FIG. 16 is a diagram illustrating the temporal change in the temperature of the molten weld pool 23W and the temporal change in the output of the laser lights coming from the laser devices 111 and 112 (110) during the welding according to the second embodiment. In FIG. 16, the notation regarding the temperature is same the notation given in FIG. 11 according to the first embodiment. Regarding the output of the laser lights, the temporal change in the output of the first-type laser lights (main beams) is illustrated as a solid line, and the temporal change in the output of the second-type laser lights (sub-beams) is illustrated as a dashed line.

As illustrated in FIG. 16, in the second embodiment, the laser device 111 starts the output at the timing t0 and stops the output at a timing t2. In contrast, the laser device 112 starts the output at the timing t0 and stops the output at a timing tk that arrives after the timing t2. After the timing tk, the molten weld pool 23W is naturally cooled in the ordinary temperature atmosphere. As a result, the temperature of the molten weld pool 23W drops in a gradual manner.

In between the timing t0 and the timing t2, the laser lights L include the beams B1 and B2. As a result of irradiation of the laser lights L onto the workpiece W during that period of time, the molten weld pool 23W is formed. That is, in the laser welding method according to the second embodiment, the formation process of the molten weld pool 23W is carried out between the timing t0 and the timing t2.

In the period of time from the timing t2 to the timing tk, the beam B1 is not included in the laser lights L and only the beam B2 is included. Hence, the output of the laser lights L is lower than the output during the period of time from the timing t0 to the timing t2 in which the beams B1 and B2 are included. During that period, the laser lights L are set in such a way that the irradiation of the laser lights L onto the molten weld pool 23W enables maintaining the molten state of the molten weld pool 23W. That is, in the laser welding method according to the second embodiment, during the period of time from the timing t2 to the timing tk, a process (hereinafter, called a maintenance process) is carried out in which, the specifications are set in regard to the irradiation of the laser lights L and the beams B1 and B2, such as the shape of the beams B1 and B2, the placement, the power density, the irradiation position, the sweeping route, and the sweeping speed. With that, the molten state of the molten weld pool 23W is temporarily maintained while holding down further formation and expansion of the molten weld pool 23W and while also holding down solidification of the molten weld pool 23W. The maintenance process can also be referred to as an extension process.

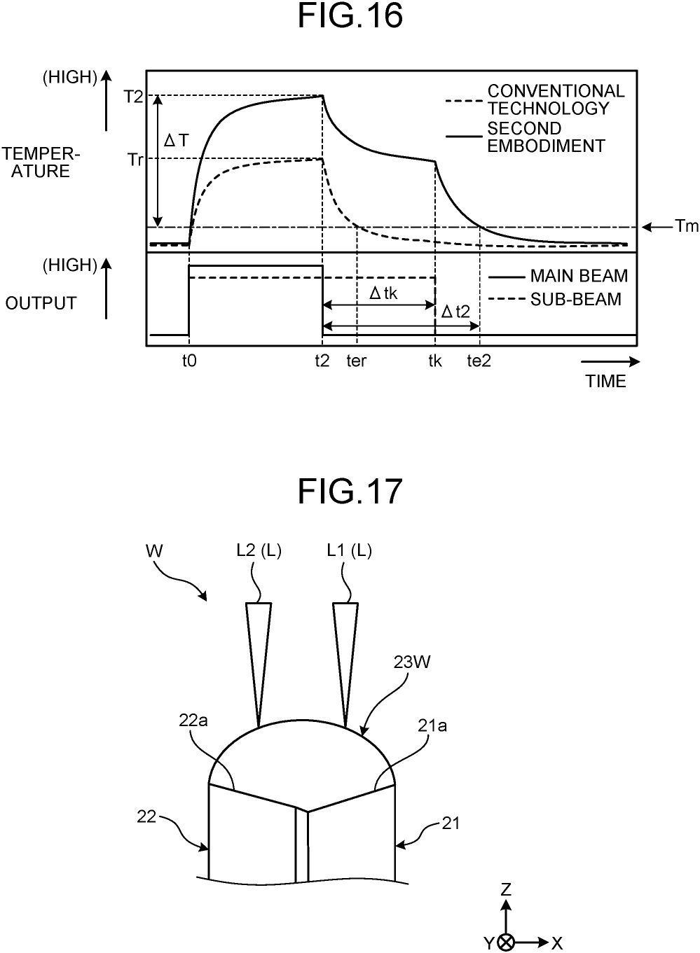

FIG. 17 is a side view of the workpiece W during the maintenance process in the laser welding method. As illustrated in FIG. 17, during the maintenance process, the laser lights L1 and L2 (L) are emitted onto the molten weld pool 23W. Moreover, in the maintenance process too, as illustrated in FIG. 10, the laser lights L1 and L2 (L) can be swept while being linearly emitted. Meanwhile, the irradiation position, the sweeping route, and the sweeping speed may or may not be same as during the formation process. Moreover, during the maintenance process, the laser lights L1 and L2 (L) can be emitted onto a wider range than the range of irradiation during the formation process.

As is clear from FIG. 16, as a result of involving the maintenance process, a temperature drop period Δt2 that is required for a temperature T2 during the formation process of the molten weld pool 23W to drop to the melting temperature Tm can be set to be longer than the temperature drop period Δt1 according to the first embodiment. That is, as a result of including the period of time for the maintenance process (Δtk=t1-t2, the maintenance period), the temperature drop period Δt2 becomes longer than the temperature drop period Δt1.

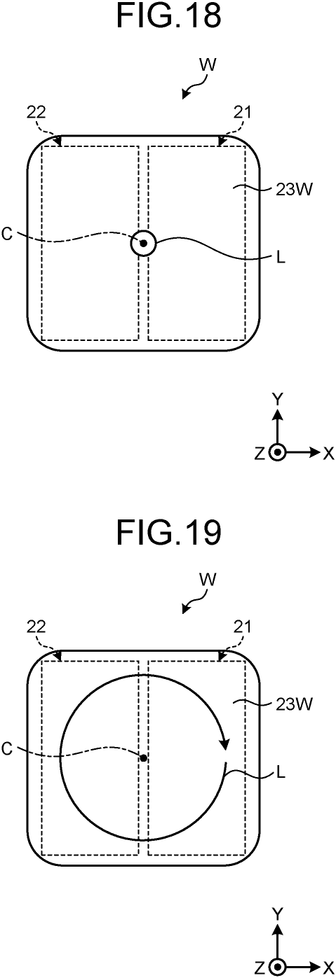

FIGS. 18 to 20 are planar views illustrating the irradiation position of the laser light L or the sweeping route of the laser light L with respect to the molten weld pool 23W during the maintenance process. That is, FIGS. 18 to 20 are diagrams viewed from the direction of irradiation of the laser light L. In FIG. 18 is illustrated a case in which the laser light L is emitted onto the center C in the planar view of the molten weld pool 23W. In FIG. 19 is illustrated a case in which the laser light L is swept along a route curved around the center C. In FIG. 20 is illustrated a case in which the laser light L is swept along a route bent around the center C. In the cases illustrated in FIGS. 19 and 20, the circling count for the sweeping can be equal to one, or can be smaller than one, or can be equal to or greater than two. In those cases, under the condition that the heat attributed to the laser light L is transmitted (reaches) across the entire molten weld pool 23W, the voids V escape from the molten weld pool 23W in the molten state, there enabling achieving reduction in the voids V in the molten weld pool 23. During the maintenance process, the laser light L can be emitted either continuously or intermittently. For example, in the case illustrated in FIG. 18, the laser light L can be intermittently emitted onto the center C. Alternatively, the laser light L can be intermittently emitted while getting swept in the trajectory illustrated in FIGS. 19 and 20. Meanwhile, instead of the case in which the laser light L is intermittently emitted onto a single point as illustrated in FIG. 18, the laser light can be sequentially emitted onto a plurality of points. Moreover, as are the cases illustrated in FIGS. 19 and 20, since the laser light L gets swept along the route bent around the center C, if a swirl flow (of a laminar flow) having less disturbance is formed in the molten weld pool 23W, the voids V can escape more easily from the molten weld pool 23W due to the movement attributed to buoyancy and the movement of the fluid.

Moreover, when the laser light L is emitted onto the molten weld pool 23W, on the outer surface of the molten weld pool 23W, an indent is formed in the region emitted with the laser light L (an indent in the opposite direction to the Z direction, hereinafter simply called the indent). According to the study undertaken by the inventors, it was found that, if the indent formed due to the irradiation of the laser light L during the maintenance process is shallower than the indent formed due to the irradiation of the laser light L during the process of forming the molten weld pool 23W, then it becomes possible to perform welding having a better quality and having less sputtering and less voids V. The indent becomes deeper according to the power density. Hence, it is implied that the power density of the laser light L on the outer surface of the molten weld pool 23W during the maintenance process is preferably lower than the power density of the laser light L on the outer surface of the molten weld pool 23W during the process of forming the molten weld pool 23W.

With reference to FIG. 14, the depth of such an indent can be measured by configuring the sensor 150 as an optical coherence tomography (OCT) sensor. In the laser welding device 100A illustrated in FIG. 14, the controller 200 can control the power of the laser device 110 in such a way that the indent formed during the maintenance process becomes shallower than the indent formed during the process of forming the molten weld pool 23W or in such a way that, during the maintenance process, the indent is formed to be equal or smaller than a predetermined value.

### Power Density

According to the experimental study conducted by the inventors, it was found that there is an optimum range for the power density [W/cm²] of the laser light L, which is emitted during the maintenance process, on the outer surface of the molten weld pool 23W.

TABLE 1

| | | | | | | |
|---|---|---|---|---|---|---|
| Range | Pd≤ 1.0×10³ | 1.0×10³< Pd≤1.0×10⁴ | 1.0×10⁴< Pd≤1.0×10⁵ | 1.0×10⁵< Pd≤1.0×10⁶ | 1.0×10⁶< Pd≤1.0×10⁷ | 1.0×10⁷ <Pd |
| Determination | Poor | Manageable | Excellent | Excellent | Good | Poor |

In Table 1 is illustrated the determination result that was obtained as a result of carrying out an experiment regarding a plurality of samplers having different power densities of the laser light and that indicates the welding quality based on the number of voids V present in the molten weld pool 23W according to the range of the power density. In the measurement of the number of voids V, such voids V are counted which have the diameter equal to or greater than 100 [µm] within a single cross-sectional surface viewed from a side face of a post-welding sample. In the determination, “excellent” indicates that the number of voids is equal to or smaller than 10; “good” indicates that the number of voids V is greater than 10 but equal to or smaller than 20; “manageable” indicates that the number of voids V is greater than 20 but equal to or smaller than 30; and “poor” indicates the number of voids V is greater than 30.

As illustrated in Table 1, it was found that a power density Pd is preferably equal to or lower than 10⁷ [W/cm²] and is more preferably equal to or lower than 10⁶ [W/cm²]. That is because, if the power density Pd is too high, it can be estimated that a keyhole gets formed in the molten weld pool 23W and there is an increase in sputtering and in turn an increase in the number of voids V.

Moreover, it was found that the power density Pd is preferably equal to or higher than 10³ [W/cm²] and is more preferably higher than 10⁴ [W/cm²]. That is because, if the power density Pd is too low, it can be estimated that the molten state of the molten weld pool 23W cannot be sufficiently maintained, and that the molten weld pool 23W gets solidified more quickly.

As explained above, in the laser welding method and the laser welding device 100A according to the second embodiment, after the process of forming the molten weld pool 23W (i.e., the formation process), it is possible to perform the process of temporarily maintaining the molten weld pool 23W in the molten state by emitting the laser lights L1 and L2 (L) onto the molten weld pool 23W (i.e., the maintenance process).

Thus, according to the second embodiment, it becomes possible to further reduce the voids V in the welded part 23, and further hold down a decline in the strength of the welded part 23 as caused by the voids V.

Moreover, according to the second embodiment too, as the effect of the maintenance process, it becomes possible to achieve the state in which the number of voids V present in the lower half R1 in the molten part 23 becomes equal to or smaller than the number of voids V present in the upper half Ru.

### Third Embodiment

### Block Diagram of Laser Welding Device and Sequence Of operations

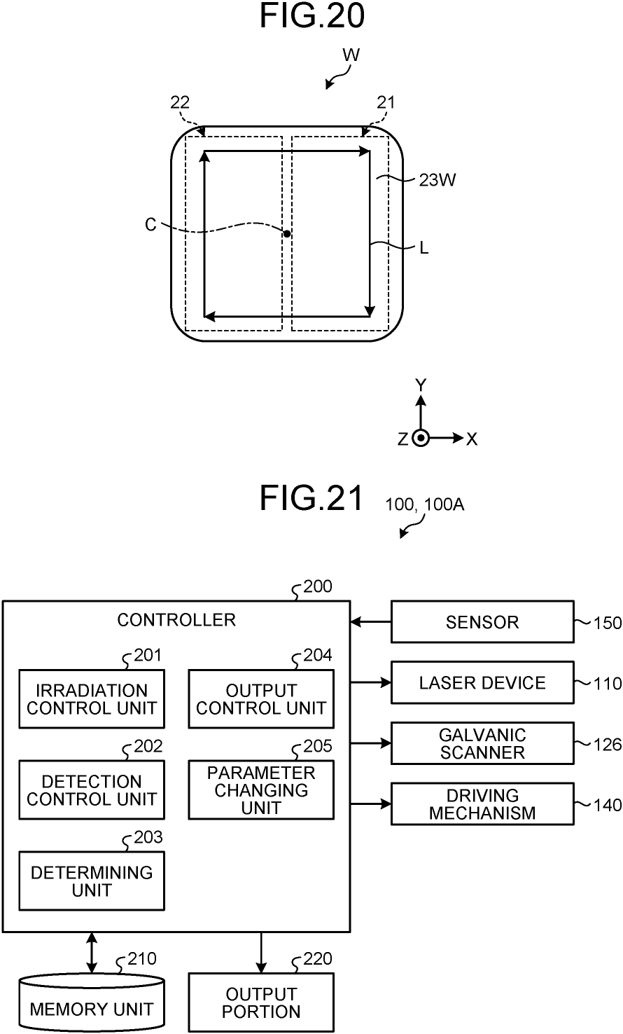

FIG. 21 is a block diagram of the laser welding devices 100 and 100A. The laser welding devices 100 and 100A include, for example, the controller 200, a memory unit 210, the sensor 150, the laser device 110, the galvanic scanner 126, the driving mechanism 140, and an output portion 220.

The controller 200 is a computer that includes a processor (circuit) such as a central processing unit (CPU); and main memory units such as a random access memory (RAM) and a read only memory (ROM). The controller 200 is, for example, a micro controller unit (MCU). The memory unit 210 includes a nonvolatile memory device such as a solid state drive (SSD) or a hard disk drive (HDD). The controller 200 is an example of a controller. The memory unit 210 can also be referred to as an auxiliary memory device.

The processor reads computer programs stored in the ROM or the memory unit 210, and executes operations so as to operate as an irradiation control unit 201, a detection control unit 202, a determining unit 203, an output control unit 204, and a parameter changing unit 205. The computer programs can be recorded as installable files or executable files in a computer-readable recording medium. The recording medium can also be called a computer program product. The computer programs, the values used in the arithmetic operations performed by the processor, and information such as tables and maps either can be stored in advance in a ROM or the memory unit 210, or can be stored in a memory unit of a computer connected to a communication network and can be downloaded into the memory unit 210 via the communication network. The memory unit 210 is used to store the data written by the processor. Meanwhile, the arithmetic operations performed by the controller 200 can be at least partially implemented using hardware. In that case, the controller 200 can include, for example, a field programmable gate array (FPGA) or an application specific integrated circuit (ASIC).

The output portion 220 is a device capable of outputting information indicating determination results in the form of sounds or images. Examples of the output portion 220 include a monitor (display), a speaker, a buzzer, and a printer. Alternatively, the output portion 220 can be a communication unit that outputs the determination results to devices on the outside of the controller 200.

### Flow of Outputting Examination Result

FIG. 22 is a flowchart for explaining a flow of operations performed to output an examination result. As illustrated in FIG. 22, firstly, the controller 200 functions as the irradiation control unit 201 to control the laser device 110, the galvanic scanner 126, and the driving mechanism 140 so as to ensure that the laser lights L are emitted onto the workpiece W according to a predetermined sequence and that the workpiece W is welded (S11). At S11, as explained earlier, the irradiation control unit 201 controls the operations of at least either the laser device 110, or the galvanic scanner 126, or the driving mechanism 140 in such a way that the laser lights L are emitted onto the workpiece W according to the specifications of the beams B1 and B2 that cause the temperature drop periods Δt1 and Δt2 required for enabling the escape of at least one void V from the molten weld pool 23W, and according to the maintenance period Δtk. The laser device 110, the galvanic scanner 126, and the driving mechanism 140 represent the control targets for the controller 200 in the laser welding devices 100 and 100A, as well as represent an example of a variation causing mechanism enabling changing the irradiation state of the laser lights L. Meanwhile, the irradiation control unit 201 and the controller 200 represent examples of a controller.

Subsequently, the controller 200 functions as the detection control unit 202 and detects the temperature of the molten weld pool 23W (S12). At S12, for example, the detection control unit 202 either can detect the maximum temperature of the molten weld pool 23W or can detect the temperature of the molten weld pool 23W corresponding to at least one timing since the elapse of a predetermined period of time from the irradiation start timing (i.e., the timing t0) .

Then, the controller 200 functions as the determining unit 203 and determines the quality of the welded part 23 based on the temperature detection result (S13). At S13, the determining unit 203 determines the quality according to a predetermined determination criterion. For example, if the detected temperature at a predetermined point of time is equal to or higher than a threshold value corresponding to that predetermined point of time, then the determining unit 203 determines that the quality of the welded part 23 is good. However, if the detected temperature is lower than the threshold value, then the determining unit 203 determines that the quality of the welded part 23 is poor. The threshold temperature corresponding to the correctness of the determination result, and the examination timing are set in advance from the experimental result.

Subsequently, the controller 200 functions as the output control unit 204 and controls the output portion 220 in such a way that the determination result is output in a predetermined output format (S14).

Then, the controller 200 functions as the parameter changing unit 205 and, according to the determination result, changes the variable control parameters related to the irradiation of the laser lights L (S15). At S15, examples of the variable control parameters include the output of the laser device 110, the output period of the laser device 110, the output period of the beam B1, and the output period of the beam B2. The parameter changing unit 205 stores the changed values of the parameters in the memory unit 210. At the time of performing identical laser welding from the next time onward, the controller 200 reads the control parameters stored in the memory unit 210, and controls the control targets including the laser device 110, the galvanic scanner 126, and the driving mechanism 140 in such a way that laser welding is performed according to the stored control parameters, that is, according to the changed control parameters.

### Flow of Operations for Void Suppression Control

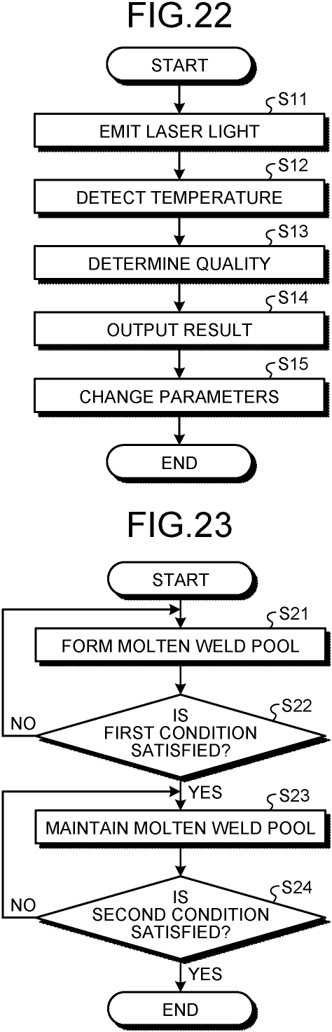

FIG. 23 is a flowchart for explaining a flow of operations performed for void suppression control. As illustrated in FIG. 23, firstly, the controller 200 functions as the irradiation control unit 201 and controls the control targets including the laser device 110, the galvanic scanner 126, and the driving mechanism 140 in such a way that the laser light L is emitted onto the workpiece W in a predetermined sequence and that the molten weld pool 23W is formed (S21). The operation at S21 represents the formation process for forming the molten weld pool 23W. At S21, the controller 200 also functions as the detection control unit 202 and detects the temperature of the molten weld pool 23W at predetermined timings, for example, at regular time intervals.

Meanwhile, at S21, the controller 200 can perform feedback control of the control targets (the variation causing mechanism) including the laser device 110, the galvanic scanner 126, and the driving mechanism 140 so as to ensure that the temperature of the molten weld pool 23W is maintained at a predetermined temperature or undergoes transition according to a predetermined temporal change.

Then, the controller 200 functions as the determining unit 203 and determines whether or not a predetermined condition (a first condition) regarding the formation process of the molten weld pool 23W is satisfied (S22). At S22, for example, based on the temporal change in the temperature of the molten weld pool 23W, if the period of time having the temperature equal to or higher than a first threshold temperature continues for a first threshold time period or beyond, then the determining unit 203 determines that the first condition is satisfied. As a result, the molten weld pool 23W and the members 20 can be brought to such a state in which it becomes possible to secure the temperature drop periods Δt1 and Δt2 at a sufficient level for enabling the escape of the voids V.

If the first condition is not satisfied (No at S22), then the formation process at S21 is continued for forming the molten weld pool 23W. When the first condition is satisfied (Yes at S22), the flow of operations is ended with respect to the laser welding device 100 according to the first embodiment. As far as the laser welding device 100A according to the second embodiment is concerned, the system control proceeds to S23.

At S23, the controller 200 functions as the irradiation control unit 201 and controls the control targets including the laser device 110, the galvanic scanner 126, and the driving mechanism 140 in such a way that the laser lights L, for example, only the beams B2 are emitted onto the workpiece W according to a predetermined sequence and the molten state of the molten weld pool 23W is maintained (S23). The operation at S23 represents the maintenance process regarding the molten weld pool 23W. At S23, the controller 200 functions as the detection control unit 202 and detects the temperature of the molten weld pool 23W at predetermined timings, for example, at regular time internals.

Meanwhile, at S23, the controller 200 can perform feedback control of the control targets (the variation causing mechanism) including the laser device 110, the galvanic scanner 126, and the driving mechanism 140 so as to ensure that the temperature of the molten weld pool 23W is maintained at a predetermined temperature or undergoes transition according to a predetermined temporal change.

Subsequently, the controller 200 functions as the determining unit 203 and determines whether or not a predetermined condition (a second condition) regarding the maintenance process of the molten weld pool 23W is satisfied (S24). At S24, for example, based on the temporal change in the temperature of the molten weld pool 23W, if the period of time having the temperature equal to or higher than a second threshold temperature continues for a second threshold time period or beyond, then the determining unit 203 determines that the second condition is satisfied. As a result, it becomes possible to secure the maintenance time period Δtk and in turn to secure the temperature drop period Δt2 sufficient for enabling the escape of the voids V.

If the second condition is not satisfied (No at S24), then the maintenance process at S23 is continued for maintaining the molten weld pool 23W. When the second condition is satisfied (Yes at S24), the flow of operations is ended.

As explained above, according to the second embodiment, the laser welding devices 100 and 100A can include the sensor 150 that detects the temperature of the molten weld pool 23W, and can include the output portion 220 that outputs information indicating the welding quality based on the detection result obtained by the sensor 150.

With such a configuration and such control, the presence or absence of the voids V in the welded part 23 can be examined relatively easily in a non-destructive manner; and the control parameters of the laser welding devices 100 and 100A can be changed based on the determination result about the welding quality. That enables achieving enhancement in the welding quality during laser welding from the next time onward.

Moreover, as explained in the second embodiment, the controller 200 can control the operations of the control targets (the variation causing mechanism) including the laser device 110, the galvanic scanner 126, and the driving mechanism 140 based on the detection result obtained by the sensor 150 that detects the temperature of the molten weld pool 23W.

With such a configuration and such control, the formation of the molten weld pool 23W and the maintenance thereof in the molten state can be performed with a higher degree of accuracy. That offers advantages such as enabling holding down the formation of the voids V in a more reliable manner and reducing unnecessary energy consumption while holding down the formation of the voids V.

While certain embodiments and modification examples have been described, these embodiments and modification examples have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions. Moreover, regarding the constituent elements, the specifications about the configurations and the shapes (structure, type, direction, shape, size, length, width, thickness, height, number, arrangement, position, material, etc.) can be suitably modified.

For example, the laser welding device can include a plurality of laser devices (laser light sources) for outputting the laser lights having the same wavelength.

Moreover, for example, at the time of irradiation of the laser light, a known type of wobbling, weaving, and output modulation can be performed, and the surface area of the molten weld pool can be adjusted.

According to the disclosure, for example, it becomes possible to provide a new and improved laser welding method and a new and improved laser welding device that, for example, enable holding down the formation of voids.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A laser welding method comprising:
forming a molten weld pool by emitting laser light including a main power region and a sub-power region onto a workpiece, the main power region including at least one main beam, the sub-power region including at least one sub-beam having a lower power density than power density of the main beam; and
solidifying the molten weld pool, wherein
the sub-beam is emitted onto the workpiece such that a void formed inside the molten weld pool escapes to outside of the molten weld pool before the molten weld pool becomes solidified.

2. The laser welding method according to claim 1, wherein the forming of the molten weld pool includes emitting the laser light such that, in a welded part formed as a result of solidification of the molten weld pool, number of voids present in lower half is equal to or smaller than number of voids present in upper half.

3. The laser welding method according to claim 1, wherein the main power region is positioned on inside of outer edge of the sub-power region.

4. The laser welding method according to claim 1, wherein
the sub-power region includes, as the at least one sub-beam, a plurality of sub-beams, and
the main beam is surrounded by the plurality of sub-beams.

5. The laser welding method according to claim 1, wherein the sub-power region includes, as the at least one sub-beam, a single sub-beam that surrounds the main power region.

6. The laser welding method according to claim 1, further comprising temporarily-maintaining that, after implementation of the forming of the molten weld pool, includes emitting the laser light onto the molten weld pool to temporarily maintain the molten weld pool in molten state.

7. The laser welding method according to claim 6, wherein, in the temporarily-maintaining of the molten weld pool in molten state, power of the laser light is reduced as compared to power in the forming of the molten weld pool.

8. The laser welding method according to claim 6, wherein, in the temporarily-maintaining of the molten weld pool in molten state, power of the main beam is reduced as compared to power in the forming of the molten weld pool.

9. The laser welding method according to claim 6, wherein an indent formed on outer surface of the molten weld pool due to irradiation of the laser light in the temporarily-maintaining of the molten weld pool in molten state is shallower than an indent formed on outer surface of the molten weld pool due to irradiation of the laser light in the forming of the molten weld pool.

10. The laser welding method according to claim 6, wherein, in the temporarily-maintaining of the molten weld pool in molten state, power density of the laser light on outer surface of the molten weld pool is equal to or lower than 10⁷ [W/cm²].

11. The laser welding method according to claim 10, wherein, in the temporarily-maintaining of the molten weld pool in molten state, the power density of the laser light on the outer surface of the molten weld pool is equal to or lower than 10⁶ [W/cm²] .

12. The laser welding method according to claim 6, wherein
in the forming of the molten weld pool, the main beam is emitted, and
in the temporarily-maintaining of the molten weld pool in molten state, irradiation of the main beam is stopped.

13. The laser welding method according to claim 6, wherein, from the forming of the molten weld pool to the temporarily-maintaining of the molten weld pool in molten state, irradiation period of the main beam is shorter than irradiation period of the sub-beam.

14. The laser welding method according to claim 1, wherein the main beam has a same wavelength as wavelength of the sub-beam.

15. The laser welding method according to claim 1, wherein the main beam has a different wavelength from wavelength of the sub-beam.

16. The laser welding method according to claim 15, wherein
wavelength of the main beam is equal to or greater than 800 [nm] and equal to or smaller than 1200 [nm], and
wavelength of the sub-beam is equal to or smaller than 550 [nm].

17. The laser welding method according to claim 1, wherein a plurality of beams included in at least one of the main power region and the sub-power region are formed by a beam shaper.

18. The laser welding method according to claim 1, wherein the laser light is swept while getting emitted onto the workpiece.

19. The laser welding method according to claim 18, wherein, with respect to the main power region, at least a part of the sub-power region is positioned at back of sweeping direction of the laser light relative to the workpiece.

20. The laser welding method according to claim 18, wherein the laser light is swept in a linear manner.

21. The laser welding method according to claim 18, wherein, in the temporarily-maintaining of the molten weld pool in molten state, the laser light is emitted onto a fixed point.

22. The laser welding method according to claim 18, wherein, in the temporarily-maintaining of the molten weld pool in molten state, when viewed in direction of irradiation of the laser light, the laser light is swept along a route that is curved around center of the molten weld pool.

23. The laser welding method according to claim 1, wherein the workpiece is made of either one of a copper based metallic material, an aluminum based metallic material, a nickel based metallic material, an iron based metallic material, and a titanium based metallic material.

24. The laser welding method according to claim 1, wherein the molten weld pool is formed in a bridged manner over a first end portion of a first member in a first direction and a second end portion of a second member in the first direction, the first member being made of a metallic member, the second member being made of a metallic member, the second member being adjacent to the first member in a second direction intersecting with the first direction such that a distance between the first end portion and the second end portion along the first direction is equal to or greater than zero.

25. The laser welding method according to claim 24, wherein a member constituting the workpiece is a conductor in form of a rectangular wire.

26. A laser welding device comprising:
a laser oscillator; and
an optical head configured to emit laser light radiated from the laser oscillator, onto a workpiece, wherein
the laser light includes at least one main beam and includes at least one sub-beam having lower power density than power density of the main beam, and
the laser light is emitted such that molten weld pool is formed on the workpiece, and
the sub-beam is emitted onto the workpiece such that a void formed inside the molten weld pool escapes to outside of the molten weld pool before the molten weld pool becomes solidified.

27. The laser welding device according to claim 26, further comprising:
a sensor configured to detect temperature of the molten weld pool; and
an output portion configured to output information indicating welding quality based on detection result obtained by the sensor.

28. The laser welding device according to claim 26, further comprising:
a sensor configured to detect temperature of the molten weld pool;
a variation causing mechanism that is capable of changing irradiation state of the laser light; and
a controller configured to control operation of the variation causing mechanism based on detection result obtained by the sensor.
